(19) United States
(12) Patent Application Publication
(10) Pub. No.: US 2005/0256729 A1
(43) Pub. Date: Nov. 17, 2005

(54) Method of immigration and business linking system

(75) Inventors: John K. Park, Diamond Bar, CA (US); Byung Chul Lee, Irvine, CA (US)

Correspondence Address: PARK & SUTTON LLP, 3255 WILSHIRE BLVD, SUITE 1110, LOS ANGELES, CA, 90010, US

(73) Assignee: PARK AND SUTTON LLP

(21) Appl. No.: 10/847,491

(22) Filed: May 17, 2004

(51) Int. Cl. G06F 17/60

(52) U.S. Cl. 705/1

(57) ABSTRACT

A method for immigration and business linking system comprise of the steps of (1) entering the business information of a given business to form main business data; (2) analyzing the main business data for the profitability of the business; (3) sorting the main business data to form basic data and allowing the basic data to be accessible by a basic data user; (4) analyzing at least a part of the main business data for the suitability for immigration programs allowed by the government to form suitable-for-immigration data; and (5) adding immigration law information to the suitable-for-immigration data to form one or more finalized databases to be accessible by a finalized database user through the finalized database display.

### BACKGROUND

The present invention relates to a method for immigration and business linking system which links the potential investors abroad interested in immigration to the United States with the up-to-date businesses for sale information. This system is best utilized through World Wide Web, known as Internet™. United States is found on streams of immigrants coming from all over the world.

United States has been providing homes for many pursuing the American Dream. Many potential immigrants from all over the world seek to live and own businesses in the United States. Whether they are seeking immigration or seeking business opportunities, unless they are qualified as experts in demand in the United States, the greatest challenge they have in the United States is finding the suitable businesses from which their livelihood can be maintained.

Although the problem in lack of business information for these foreign investors has been identified in the past, no one was able to provide up-to-date and accurate businesses-for-sale information to people abroad. The problems lie with several factors, including and not limited to (1) the distance between the potential buyer and the potential seller, (2) the inability for the potential buyer to obtain a visa to enter into the United States to investigate the potential business purchase, (3) lack of the business profitability information on the database, (4) the listing agents were afraid to list the accurate information on the computers in fear of others stealing the business listings, (5) lack of legal analysis of the available businesses related to the United State immigration policies, (6) lack of the commitment from the potential seller that the seller would cooperate with the government's immigration protocols, and numerous other difficulties.

This present system reduces the above-identified problems and also reduces the risk of misuse of information against the listing agent's desires. Moreover, up-to-date and accurate businesses-for-sale information can be obtained anywhere in the world, with the business already screened for the seller's willingness to cooperate under the protocols of the available immigration programs and with the appropriate legal analysis according to the United States Immigration Programs.

### SUMMARY

The simplest version of this invention includes three basic steps. First, enter the business information of a given businesses-for-sale into a database to form main business data. Second, analyze the main business data to evaluate the profitability of the business. Third, analyze the main business data against the available immigration program requirements of the government to verify that the business would qualify as a suitable business for a potential immigrant or a business investor satisfying the legal requirements and making satisfactory income. One of the important aspects of the invention is that the database is available on the World Wide Web, Internet™, so anyone in the world may access the database. More detailed description of the system, along with the synergetic and cooperative effect among various professional firms to make the system successful, is illustrated in the Description section herewith.

One of the most difficult problems for foreign investors, whether they are seeking immigration into the Unites States or merely interested in purchasing businesses as investments, is obtaining accurate and up-to-date businesses-for-sale information with financial and accounting information. The problem is less severe when the foreign person is seeking to purchase a home in the United States. For people interested in purchasing homes, a residence listing service, called Multi-Listing Service (MLS), is available to potential homebuyers, whether the buyers are located in the United States or elsewhere. Much information is available on the MLS. However, when a person is interested in purchasing a business, it is quite a different story.

There are some listing services for businesses-for-sale available in the United States. However, the information available on the listed businesses are very limited, and do not contain financial information. Moreover, because many listing agents are very concerned with other agents approaching the sellers of the businesses and stealing the listing away, much of the limited information that is available is incorrect and sparse. In addition to that, no one has compared the business information against the current immigration laws to verify that such businesses would qualify under the immigration programs. Moreover, no database reflects whether the seller would cooperate with the buyer through the lengthy, and perhaps difficult, immigration program protocols in order to sell his or her business.

Therefore, a potential buyer abroad has had very difficult time finding a suitable business without entering into the United States, and even when the buyer thought he or she had found a good business to purchase, he or she was often disappointed to find out the seller would not cooperate with the buyer through the paperwork and the extended time necessitated to close the transaction while securing an approval of Immigration and Naturalization Service (INS). The problem is compounded for people who are interested in small businesses, because there are substantially less financial incentives for the sellers to cooperate and the brokers provide detailed information. Therefore, there is a great need for a system that links the foreign investors who are interested in purchasing small businesses in the United States.

### BRIEF DESCRIPTION OF THE DRAWINGS

FIG. 1 illustrates a simple flow chart of the system functions; and

FIG. 2 illustrates a simplified display of a custom data.

### DESCRIPTION

A method for immigration and business linking system is described herewith. This innovative system is designed to link the foreign investors, especially those who are seeking to purchase small businesses in the United States for investment purposes, to the current and up-do-date businesses-for-sale information. The system is designed to be simple and convenient for the users.

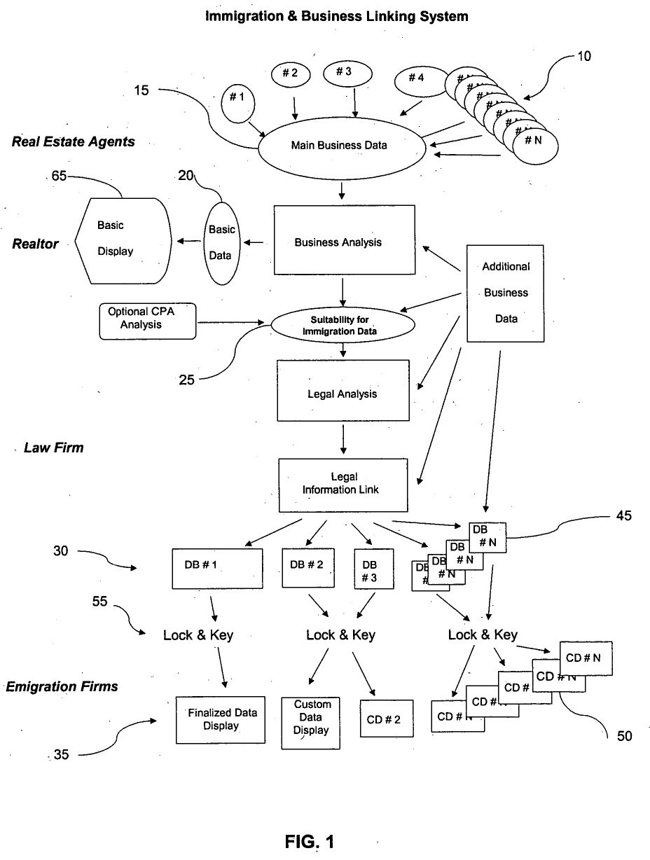

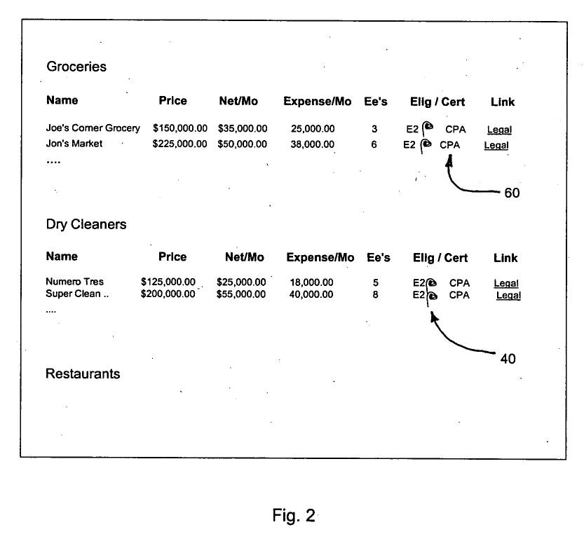

Referring to FIG. 1 and FIG. 2, the simplified version of the method for immigration and business linking system comprise of the steps of (1) entering the business information 10 of given businesses to form main business data 15; (2) analyzing the main business data 15 for the profitability of the business; (3) sorting the main business data 15 to form basic data 20 and allowing the basic data 20 to be accessible by a basic data user; (4) analyzing at least a part of the main business data 15 for the suitability for immigration programs allowed by the government to form suitable-for-immigration data 25; and (5) adding immigration law information to the suitable-for-immigration data 25 to form one or more finalized databases 30 to be accessible by a finalized database user through the finalized database display 35.

FIG. 1 shows the business information 10, represented as #1, #2 . . . #N, gathered from various sources being collected to form the main business data 15. In order to best provide the latest and the most up-to-date business information, the step of gathering the business information 10 is comprised of collecting, including and not limited to, the sales, financial and operational information about the businesses for sale. This valuable business information 10 are gathered substantially by real estate professionals so that at least the sales price, the revenue and the expenses of the businesses are identified to analyze and calculate the business profitability.

The business analysis includes reviewing and calculating the business profitability. To the most investors, the profitability of the business is the most important concern. This is especially true for immigrants. To them, the business represents not only an investment, but also the business is often their only means of livelihood. More than that, the purpose of this invention is to help potential immigrants to qualify for immigration under the approved programs of the United States government, the profitability analysis and the availability of profitability information is very important information. Many U.S. immigration policies require clear showing of the business profitability in order to qualify the immigrants to immigrate. Therefore, this system provides that not only the profitability may be analyzed, calculated and identified, the brokers and professionals may update and process this up-to-date business information 10 so that the end users may be able to analyze the businesses for themselves.

As explained earlier, serious difficulties existed when the willing buyer, often through a difficult search, contacts the willing seller only to find out that the seller would not either wait for the buyer to process the immigration processes required by the government, or willing to prepare additional voluminous paperwork for the seller. In addition to that many brokers were unaware of the immigration protocols or procedures at INS. Therefore, this invention provides for the suitability for immigration analysis that includes the step of receiving cooperative agreement from the seller of the business that the seller would cooperate with the government's immigration procedure documentations and protocols. Moreover, once processed, the suitability for immigration programs is identified by a suitability identifier 40 (as shown on FIG. 2) on the display of one or both of the basic data 20 and the finalized data. The suitability identifier 40 may be a flag that identifies a given business as one that would satisfy one or more United States immigration program requirements or that identifies that the seller has agreed to cooperate with the buyer's need to satisfy the immigration law procedures and protocols. The suitability identifier 40 may be simply words such as “E2” to identify that the business has been qualified by having the seller agreed to work with the buyer through the immigration protocols. The suitability identifiers 40, including the flag, are shown in FIG. 2, under the category titled “Elig”, which means “Eligibility”; of course the suitability identifiers 40 may be grouped under different headings or under no heading at all.

The finalized data may be accessed by the end users anywhere via World Wide Web. The entirety of the finalized data may be accessed by one or more emigration partners abroad. However, because it may be preferable to have more than one exclusive relationship with a foreign emigration agency, a preferred version of the system takes the finalized data 30 and break it up into several custom data 45, so that different end user may have access to different set of businesses. As each end user accesses different business information, whether through the viewing of the finalized data display 35 or the custom data display 50, the system may promote competition and may serve a large customer base, while the partnered foreign emigration agencies do not have to compete over the same businesses.

Another difficulty the potential foreign investors faced is that not only the business information 10 was unavailable, but also it was difficult to obtain the latest immigration law requirements. The result was that the investor had to visit United States, retain a business broker and search the market for a suitable business, and then consult an attorney about immigration law information. However, this system allows the law professionals to provide legal information customized to fit a specific business for sale before the potential investor spends time searching and evaluating profitable businesses.

The system allows the immigration law information, as well as the financial information of the businesses, to be available to the finalized database users over the Internet™. A preferred method is to have the immigration law information hyper-linked to the business information 10 so that the end user may access the legal information by activating a hyperlink icon on a finalized database display 35 or a custom data display.

FIG. 1 shows the availability of the finalized database 30 and the customer data. The finalized database 30 is the data available to the potential end users as the whole, including the various custom data, and the custom data 45 is subdivided finalized database 30 to fit individual end user. In order to control the access of the finalized database 30 or the custom data, a preferred method is to assign one or more passwords to the custom data, individually, in groups or collectively. When a password is assigned to the entirety or a substantial part of the custom data, then the end user may access the entirety of the finalized data or a substantial part thereof, according to the password he or she has. Thereupon, the system manager may provide lock and key function 55 to each database so that selected and predetermined end user, an emigration firm, agency or its customers, may access the finalized data or the custom data 45 by entering an assigned password through the World Wide Web. The contents of the databases may be displayed accordingly; finalized data display 35 or custom data display 50.

Another difficulty the potential foreign investors faced is, because they are not familiar with the business practices in the United States, they were unable to understand the financial documents or ledgers fully to have assurances that the business records are accurate and verified. Therefore, a preferred system allows a review of the available business information 10 by a certified public accountant. This certification may be obtained at anytime, but the preferred version is to be certified the business records between the business analysis and the legal analysis. Similar to the suitability identifier 40 being displayed on the finalized data display or the custom data display, the certification of accountancy 60 (as shown on FIG. 2, under the heading of “Cert” which means “certification”) may be displayed as well.

The preferred version provides two sets of data to the end users. The first set is the basic data 20 that may be accessed by anyone. The second set is the custom data 45 accessed by the emigration firms. The basic data 20 should contain general business information 10 that is not sensitive for the public disclosure. However, certain business information, including the photos of businesses, the business addresses and actual financials of the businesses, as well as the listing period and the contact information of the listing agent, may be quite sensitive to the sellers or the brokers with the listing. Therefore, the system provides for a basic display 65 that limits the display to the basic business information and for custom display that displays the sensitive information to the selected users. This two-prong display system allows the real estate professionals to gather and enter the latest business information 10 to the system in confidence, so that the latest and the best business information 10 are available to the system. Moreover, the two-prong system allows the real estate professionals to update the information in real time basis.

Although the present invention has been described in considerable detail with regard to the preferred versions thereof, other versions are possible. Therefore, the appended claims should not be limited to the descriptions of the preferred versions contained herein.

1. A method for immigration and business linking system comprising the steps of:
a) entering the business information of a given business to form main business data;
b) analyzing the main business data for the profitability of the business; and
c) analyzing at least a part of the main business data for the suitability for immigration programs allowed by the government to form suitable-for-immigration data to form one or more finalized databases to be accessible by a finalized database user through World Wide Web.

2. The method of claim 1 further comprising the step of gathering the business information comprised of collecting the financial and operational information about the businesses for sale, gathered substantially by real estate professionals, wherein the analysis of business profitability comprises of the step of identifying the sales price, the revenue and the expenses of the businesses offered for sale.

3. The method of claim 2 wherein the suitability for immigration analysis comprises of the step of receiving cooperative agreement from the seller of the business that the seller would cooperate with the government's immigration procedure protocols, and wherein the suitability for immigration programs is identified by a suitability identifier on the display of the finalized data.

4. The method of claim 3 wherein the finalized data comprises of a plurality of custom data, wherein each custom data comprises business information of substantially different businesses.

5. The method of claim 4 further comprising the step of adding the immigration law information to the suitable-for-immigration data, wherein the immigration law information is available to the finalized database users, and wherein the finalized database user may access the immigration law information by activating a hyperlink icon on the finalized database display or one or more of the custom data displays.

6. A method for immigration and business linking system comprising the steps of:
a) entering the business information of a given business to form main business data;
b) analyzing the main business data for the profitability of the business;
c) sorting the main business data to form basic data and allowing the basic data to be accessible by a basic data user; and
d) analyzing at least a part of the main business data for the suitability for immigration programs allowed by the government to form suitable-for-immigration data to form one or more finalized databases to be accessible by a finalized database user.

7. The method of claim 6 further comprising the step of gathering the business information comprised of collecting the financial and operational information about the businesses for, sale gathered substantially by real estate professionals, wherein the analysis of business profitability comprises of the step of identifying the sales price, the revenue and the expenses of the businesses offered for sale.

8. The method of claim 7 wherein the suitability for immigration analysis comprises of the step of receiving cooperative agreement from the seller of the business that the seller would cooperate with the government's immigration procedure protocols, and wherein the suitability for immigration programs is identified by a suitability identifier on the display of one or more of the basic data and the finalized data.

9. A method for immigration and business linking system comprising the steps of:
a) entering the business information of a given business to form main business data;
b) analyzing the main business data for the profitability of the business;
c) sorting the main business data to form basic data and allowing the basic data to be accessible by a basic data user;
d) analyzing at least a part of the main business data for the suitability for immigration programs allowed by the government to form suitable-for-immigration data; and
e) adding immigration law information to the suitable-for-immigration data to form one or more finalized databases to be accessible by a finalized database user through the finalized database display.

10. The method of claim 9 further comprising the step of gathering the business information comprised of collecting the financial and operational information about the businesses for sale, gathered substantially by real estate professionals, wherein the analysis of business profitability comprises of the step of identifying the sales price, the revenue and the expenses of the businesses offered for sale.

11. The method of claim 10 wherein the suitability for immigration analysis comprises of the step of receiving cooperative agreement from the seller of the business that the seller would cooperate with the government's immigration procedure protocols.

12. The method of claim 11 wherein the suitability for immigration programs is identified by a suitability identifier on the display of one or both of the basic data and the finalized data.

13. The method of claim 12 wherein the finalized data comprises of a plurality of custom data, wherein each custom data comprises business information of substantially different businesses.

14. The method of claim 13 wherein the immigration law information is available to the finalized database users, wherein the finalized database user may access the immigration law information by activating a hyperlink icon on a finalized database display or a custom data display.

15. The method of claim 14 further comprising the step of assigning one or more passwords to the custom data, individually, in groups or collectively.

16. The method of claim 15 wherein the finalized database user or the customized user is an emigration firm or agency.

17. The method of claim 16 further comprising the step of assigning one or more passwords to the finalized data and the custom data, individually, in groups or collectively, and the step of assessing the finalized data or the custom data by entering an assigned password through the World Wide Web.

18. The method of claim 10 wherein the step of profitability analysis further comprises of the step of receiving an accounting analysis of the business for sale by a certified public accountant.

19. The method of claim 17 further comprising the step of supplementing the business information as additional business information is gathered by the real estate professionals.

20. The method of claim 19 wherein the general public is limited to the accessing the basic data and the emigration firms or agencies are limited to the selected custom data and the basic data.
